(19) United States
(12) Patent Application Publication
(10) Pub. No.: US 2007/0252755 A1
(43) Pub. Date: Nov. 1, 2007

(54) Digital Broadcasting Receiver Having Dgps Rtcm Data Output Port and Terminal Supporting Dgps Using the Same

(76) Inventors: Sammo Cho, Daejon (KR); Geon Kim, Daejon (KR); Hyun Lee, Daejon (KR); Gwang-Soon Lee, Daejon (KR); Young-Kwon Hahm, Daejon (KR); Soo-In Lee, Daejon (KR)

Correspondence Address: BLAKELY SOKOLOFF TAYLOR & ZAFMAN, 1279 OAKMEAD PARKWAY, SUNNYVALE, CA, 94085-4040, US

(21) Appl. No.: 10/580,867

(22) PCT Filed: Apr. 19, 2004
(86) PCT No.: PCT/KR04/00895

§ 371 Date: Mar. 6, 2007

(30) Foreign Application Priority Data
Nov. 24, 2003 (KR) 10-2003-0083474

(51) Int. Cl. G01S 1/02

(52) U.S. Cl. 342/357.12

(57) ABSTRACT

A digital broadcasting receiver with DGPS RTCM data output port and a terminal for supporting the DGPS service using the same are disclosed. The digital broadcasting receiver having DGPS RTCM data output port, includes: a radio frequency processing unit for receiving digital broadcasting signals and converting the received signals into baseband data; a decoding unit for decoding the baseband data to generate decoded data; a DGPS information extractor unit for extracting a Differential Global Positioning System (DGPS) information from a DGPS data which is one of the decoded data; and a RTCM104 formatting unit for converting the DGPS information into RTCM104 data which is compatible with the DGPS RTCM data input port and outputting the RTCM104 data through the DGPS RTCM data output port.

### TECHNICAL FIELD

The present invention relates to a digital broadcasting receiver having Differential Global Positioning System (DGPS) Radio Technical Commission for Maritime Service (RTCM) data output port and a terminal supporting the DGPS service using the same.

### BACKGROUND ART

Up to now, a Global Positioning System (GPS) provides more precise information than other navigation systems based on radio wave. Actually, a general GPS is enough to provide precise information in various application fields. However, for more precise information, a Differential Global Positioning System (DGPS) is developed.

Ordinarily, the DGPS is technology for supplementing the general GPS receiver having 2 dRMS of 100 meters or so. A reference station transmits precise DGPS information to remove errors in order to improve accuracy of user's position. The DGPS removes various error factors so that the DGPS can provide positioning service within 10-meters error for the roving object and 1-meter error for the stationary object. As compared with the general GPS, the DGPS can be used for navigating of not only a ship and an airplane but a vehicle and geodetic survey.

A GPS signal from a satellite and a DGPS information from other channels for compensating the satellite data are required for using the DGPS.

Ordinarily, a method for providing the DGPS information to the GPS receiver comprises a method for independently constructing a wired/wireless network and using an exclusive channel for the DGPS, a method for providing the DGPS information using an existing broadcasting network and a communication network. Herein, the method for constructing the DGPS network is expensive and required additional devices for receiving the DGPS information, on the other hand, can provide stable service. The method for using the existing service network can save the cost, on the other hand, is required appropriate technical support for satisfying requirements of the DGPS.

However, the DGPS information receiver using an independent DGPS channel or using analog/digital broadcasting channels in order to receive the DGPS information includes a receiving part receiving the DGPS signal and an processing part processing the received GPS signal from the satellite and is expensive and great in volume. That is, because the existing integrated-type DGPS terminal comprises functions of inputting RTCM104 data, receiving GPS signals and processing the DGPS signals, it couldn't help being expensive.

As shown, because the conventional DGPS receiver comprising receivers of the GPS signal and DGPS information is complex and expensive, the method using only existing GPS receiver for the DGPS is expected as being useful.

It is, therefore, an object of the present invention to provide a digital broadcasting receiver having a Differential Global Positioning System (DGPS) Radio Technical Commission for Maritime Service (RTCM) data output port and a terminal supporting the DGPS using the same, to thereby provide the DGPS service using only the existing GPS receiver.

In accordance with an aspect of the present invention, there is provided a digital broadcasting receiver with the DGPS RTCM data output port, a receiver including: a radio frequency (RF) processing unit for receiving digital broadcasting signals and converting the received signals into baseband data; a decoding unit for decoding the baseband data and classifying the decoded data according to applications; a DGPS information extracting unit for extracting DGPS correction information from a DGPS data which is output data of the decoding unit; and a RTCM104 formatting unit for converting the DGPS correction information into RTCM104 data which is compatible with the DGPS RTCM data input port of the GPS receiver and outputting the DGPS RTCM104 data through the DGPS RTCM data output port.

In accordance with another aspect of the present invention, there is provided a digital broadcasting terminal supporting the DGPS using the same, including: the RF processing unit for receiving digital broadcasting signals and converting the received signals into baseband data; the decoding unit for decoding the baseband data and classifying the decoded data according to applications; the DGPS information extracting unit for extracting the DGPS correction information from the DGPS data which is output data of the decoding unit; the RTCM104 formatting unit for converting the DGPS correction information into RTCM104 data compatible with the DGPS RTCM data input port of the GPS receiver and outputting the DGPS RTCM104 data through the RTCM data output port; and a GPS signal receiving unit for receiving the DGPS RTCM104 data through the DGPS RTCM data input port and calculating position with the DGPS information.

In accordance with another aspect of the present invention, there is provided a terminal for providing maps or geographic information based on the positioning information-received from the GPS receiving means.

In a digital broadcasting system in accordance with the present invention, in order to provide the DGPS using only the digital broadcasting receiver with the DGPS RTCM data output port and the existing GPS receiver inputting the DGPS RTCM104 data, the digital broadcasting receiver decodes the DGPS information from digital broadcasting signals received from a built-in antenna into the RTCM104 format, i.e., the DGPS data format and the digital broadcasting receiver outputs the DGPS RTCM104 data to the GPS receiver inputting the RTCM104 data and the GPS receiver calculates user's position using the DGPS RTCM104 data received from the digital broadcasting receiver.

### DISCLOSURE

It is, therefore, an object of the present invention to provide a digital broadcasting receiver having a Differential Global Positioning System (DGPS) Radio Technical Commission for Maritime Service (RTCM) data output port and a terminal supporting the DGPS using the same, to thereby provide the DGPS service using only the existing GPS receiver.

In accordance with an aspect of the present invention, there is provided a digital broadcasting receiver with the DGPS RTCM data output port, a receiver including: a radio frequency (RF) processing unit for receiving digital broadcasting signals and converting the received signals into baseband data; a decoding unit for decoding the baseband data and classifying the decoded data according to applications; a DGPS information extracting unit for extracting DGPS correction information from a DGPS data which is output data of the decoding unit; and a RTCM104 formatting unit for converting the DGPS correction information into RTCM104 data which is compatible with the DGPS RTCM data input port of the GPS receiver and outputting the DGPS RTCM104 data through the DGPS RTCM data output port.

In accordance with another aspect of the present invention, there is provided a digital broadcasting terminal supporting the DGPS using the same, including: the RF processing unit for receiving digital broadcasting signals and converting the received signals into baseband data; the decoding unit for decoding the baseband data and classifying the decoded data according to applications; the DGPS information extracting unit for extracting the DGPS correction information from the DGPS data which is output data of the decoding unit; the RTCM104 formatting unit for converting the DGPS correction information into RTCM104 data compatible with the DGPS RTCM data input port of the GPS receiver and outputting the DGPS RTCM104 data through the RTCM data output port; and a GPS signal receiving unit for receiving the DGPS RTCM104 data through the DGPS RTCM data input port and calculating position with the DGPS information.

In accordance with another aspect of the present invention, there is provided a terminal for providing maps or geographic information based on the positioning information received from the GPS receiving means.

In a digital broadcasting system in accordance with the present invention, in order to provide the DGPS using only the digital broadcasting receiver with the DGPS RTCM data output port and the existing GPS receiver inputting the DGPS RTCM104 data, the digital broadcasting receiver decodes the DGPS information from digital broadcasting signals received from a built-in antenna into the RTCM104 format, i.e., the DGPS data format and the digital broadcasting receiver outputs the DGPS RTCM104 data to the GPS receiver inputting the RTCM104 data and the GPS receiver calculates user's position using the DGPS RTCM104 data received from the digital broadcasting receiver.

### DESCRIPTION OF DRAWINGS

The above and other objects and features of the present invention will become apparent from the following description of the preferred embodiments given in conjunction with the accompanying drawings, in which:

FIG. 1 is a block diagram showing a digital broadcasting receiver having a Differential Global Positioning System (DGPS) Radio Technical Commission for Maritime Service (RTCM) data output port in accordance with an embodiment of the present invention;

FIG. 2 is a block diagram illustrating a digital broadcasting terminal in accordance with an embodiment of the present invention; and

FIG. 3 is a diagram describing an interface between the digital broadcasting receiver and the GPS receiver of FIG. 2.

### BEST MODE

Other objects and aspects of the invention will become apparent from the following description of the embodiments with reference to the accompanying drawings, which is set forth hereinafter.

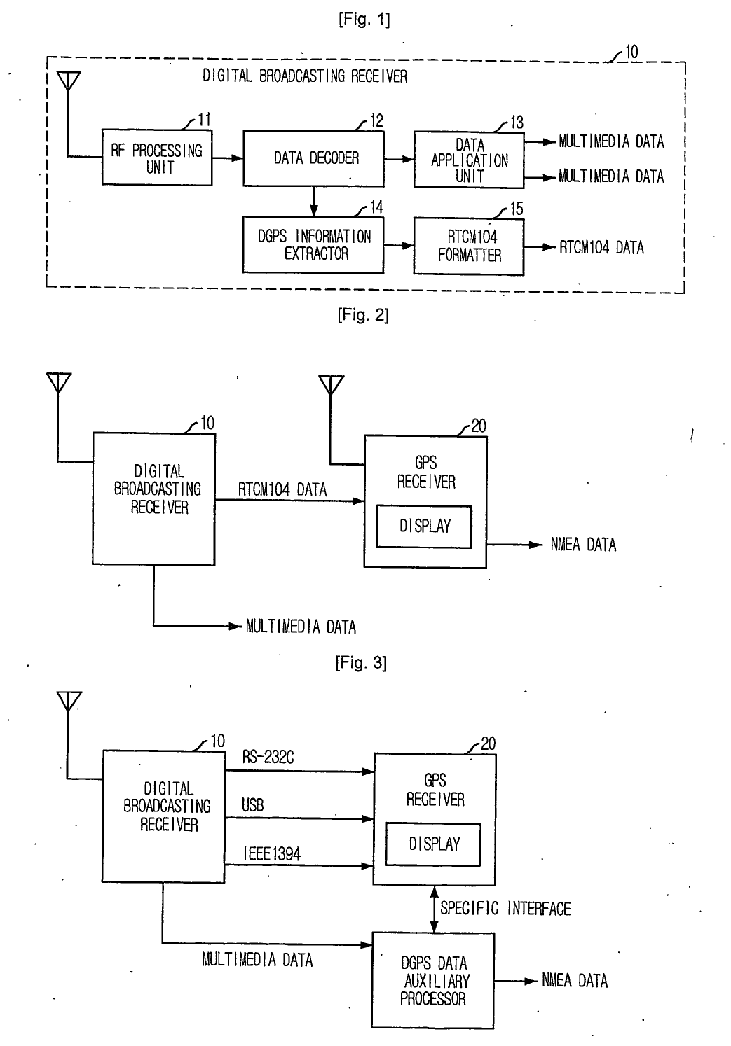

FIG. 1 is a block diagram showing a digital broadcasting receiver having a Differential Global Positioning System (DGPS) Radio Technical Commission for Maritime Service (RTCM) data output port in accordance with an embodiment of the present invention.

As shown, a digital broadcasting receiver 10 with a DGPS RTCM data output port includes a Radio Frequency (RF) processing unit 11 for receiving digital broadcasting signals and converting the digital broadcasting signals to baseband data, a data decoder 12 for decoding the baseband data and classifying the decoded data according to applications, a DGPS information extractor 14 for extracting DGPS information in the DGPS data which is output data of the data decoder and a RTCM104 formatter 15 for converting the DGPS information into RTCM104 data and outputting through the DGPS RTCM output port, e.g., a corn port for the RTCM104 data.

A digital broadcasting signal received by the digital broadcasting receiver 10 includes multiplexed data of various multimedia or the application data in one channel and the DGPS information are transmitted through one of the data channels of the digital broadcasting.

The RF processing unit 11 receives the digital broadcasting signal and demodulates the received signal into baseband data according to each of the digital broadcasting.

The data decoder 12 decodes the baseband data and outputs the decoded data to an audio and video port or a data output port according to appropriate application fields.

The DGPS information extractor 14 extracts the DGPS information from the decoded DGPS data received from the data decoder 12 and transmits the DGPS information to the RTCM104 formatter 15. The RTCM104 formatter 15 converts the DGPS information into the RTCM104 data and outputs the RTCM104 data.

Because the digital broadcasting receiver 10 with the DGPS RTCM data output port, referred to FIG. 2, can be coupled to the GPS receiver 20 through the DGPS RTCM data input port, the GPS receiver 20 can receive the RTCM104 data through the DGPS RTCM input port and can calculate high precise position. The GPS receiver 20 can provide a navigating service using a digital map for pedestrian and/or vehicles and a Geographic Information System (GIS) (not shown). The GPS receiver 20 can independently provide GPS service without the digital broadcasting signal including the DGPS information.

Therefore, the digital broadcasting terminal including the digital broadcasting receiver 10 with the DGPS RTCM data output port and the GPS receiver 20 with the DGPS RTCM data input port decodes the DGPS information into the RTCM104 data multiplexed in the digital broadcasting signal through the digital broadcasting receiver 10 and outputs the RTMC104 data. The GPS receiver 20 receives the RTMC104 data and calculates the position so that the digital broadcasting terminal can provide the DGPS with only the digital broadcasting receiver 10 and the GPS receiver 20.

As referred in FIG. 2, the digital broadcasting receiver 10 can be fixable, portable and for vehicles. In general, the user uses the general GPS receiver 20 and in particular, when wanting to know the precise position information, the user turns on the digital broadcasting receiver 10, connects the DGPS RTCM data output port to the GPS receiver's DGPS RTCM data input port 20 in order to get the high precise DGPS information.

The digital broadcasting receiver 10 and the GPS receiver 20 can be coupled to each other through RS-232 serial interface, Universal Serial Bus (USB) or Institute of Electrical and Electronics Engineers (IEEE) 1394. If the DGPS information is multiplexed in the multimedia data channel, the DGPS information can be extracted using the DGPS data auxiliary processor 30. Herein, the digital broadcasting receiver 10 can be coupled to the GPS receiver 20 through not only the RS-232C, the USB and the IEEE1394 but the predetermined interface.

As above-mentioned, the method of the present invention can be embodied as a program and stored in recording media (CD-ROM, RAM, floppy disk, hard disk, magneto-optical disk, etc.) readable by a computer.

The effect of the present invention as recited in the above is briefly summarized herein in such a way that the digital broadcasting receiver overcoming a drawback of the existing DGPS receiver including the GPS receiver and the DGPS RTCM data receiver is complex and expensive; provides the DGPS service with the digital broadcasting receiver and the existing GPS receiver. The digital broadcasting receiver decodes the RTCM data multiplexed in digital broadcasting signal into the RTCM104 data and outputs RTCM104 data to the GPS receiver so that GPS receiver calculates the position.

The present application contains subject matter related to Korean patent application no. 200383474, filed in the Korean Patent Office on Nov. 24, 2003, the entire contents of which being incorporated herein by reference.

While the present invention has been described with respect to certain preferred embodiments, it will be apparent to those skilled in the art that various changes and modifications may be made without departing from the scope of the invention as defined in the following claims.

1. A digital broadcasting receiver having a DGPS RTCM data output port, the receiver comprising:
a radio frequency processing means for receiving digital broadcasting signals and converting the received signals into baseband data;
a decoding means for decoding the baseband data to generate decoded data;
a DGPS information extractor means for extracting a Differential Global Positioning System (DGPS) information from a DGPS data which is one of the decoded data; and
a RTCM104 formatting means for converting the DGPS information into RTCM104 data which is compatible with the DGPS RTCM data input port and outputting the RTCM104 data through the DGPS RTCM data output port.

2. The receiver as recited in claim 1, wherein the DGPS data output port is a corn port for outputting RTCM104 data.

3. A digital broadcasting terminal supporting the DGPS using the digital broadcasting receiver, comprising:
a radio frequency processing means for receiving digital broadcasting signals and converting the received signals into baseband data;
a decoding means for decoding the baseband data to generate decoded data;
a DGPS information extractor means for extracting a Differential Global Positioning System (DGPS) information from a DGPS data which is one of the decoded data; and
a RTCM104 formatting means for converting the DGPS information into RTCM104 data which is compatible with the DGPS RTCM data input port and outputting the RTCM104 data through the DGPS RTCM data output port; and
a GPS receiving means for receiving the RTCM104 data through the DGPS RTCM data input port and computing position of a user based on the RTCM104 data.

4. The terminal as recited in claim 3, further comprising means for providing maps or geographic information based on the positioning information received from the GPS receiving means.

5. The terminal as recited in claim 3, wherein the Global Positioning System (GPS) receiving means independently provides the GPS service.

6. The terminal as recited in claim 3, wherein the RTCM 104 formatting means and the GPS receiving means are coupled to each other through one of RS-232 serial interface, Universal Serial Bus (USB) or IEEE1394 interface.
